(19) United States
(12) Patent Application Publication
(10) Pub. No.: US 2024/0379997 A1
(43) Pub. Date: Nov. 14, 2024

(54) ALL-SOLID-STATE BATTERY INCLUDING SILICON ANODE WITH CONCAVE SPHERICAL STRUCTURES

(71) Applicant: GM GLOBAL TECHNOLOGY OPERATIONS LLC, Detroit, MI (US)

(72) Inventors: Zhe LI, Shanghai (CN); Qili SU, Shanghai (CN); Yong LU, Shanghai (CN); Haijing LIU, Shanghai (CN)

(21) Appl. No.: 18/633,792

(22) Filed: Apr. 12, 2024

(30) Foreign Application Priority Data
May 8, 2023 (CN) 2023105125159

(51) Int. Cl. H01M 10/0562; H01M 4/131; H01M 4/134; H01M 10/0585

(52) U.S. Cl. CPC H01M 10/0562; H01M 4/131; H01M 4/134; H01M 10/0585

(57) ABSTRACT

A solid-state battery cell includes a cathode electrode includes a cathode current collector and a cathode active layer arranged on the cathode current collector and including cathode active material and a solid electrolyte. A separator layer comprises the solid electrolyte. An anode layer comprises an anode current collector and a silicon layer arranged on the anode current collector and including a plurality of concave spherical surfaces.

### CROSS-REFERENCE TO RELATED APPLICATIONS

This application claims the benefit of Chinese Patent Application No. 202310512515.9, filed on May 8, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to all-solid-state batteries, and more particularly to all-solid-state batteries including silicon anode electrodes with concave spherical structures.

Electric vehicles such as battery electric vehicles and hybrid vehicles are powered by a battery pack including one or more battery modules each having one or more battery cells. The battery cells include anode electrodes, cathode electrodes, and separators. The anode electrodes include anode active layers arranged on an anode current collector. The cathode electrodes typically include cathode active layers arranged on a cathode current collector.

All-solid-state batteries (ASSB) have the potential to be superior to state-of-the-art lithium-ion batteries in terms of abuse tolerance, working temperature range, and power capability.

### SUMMARY

A solid-state battery cell includes a cathode electrode includes a cathode current collector and a cathode active layer arranged on the cathode current collector and including cathode active material and a solid electrolyte. A separator layer comprises the solid electrolyte. An anode layer comprises an anode current collector and a silicon layer arranged on the anode current collector and including a plurality of concave spherical surfaces.

In other features, the silicon layer has a surface area in a range from 105% to 300% of a corresponding flat surface. The anode current collector is made of one or more materials selected from a group consisting of copper, stainless steel, nickel, iron, titanium, tin (Sn), and alloys thereof. The anode current collector has a surface roughness Rz in a range from 0.1 μm to 12 μm. A depth of the concave spherical surfaces is in a range from 0.1 μm to 20 μm. The anode current collector has a thickness in a range from 4 μm to 30 μm.

In other features, the cathode active layer includes the solid electrolyte in a range from 1 to 50 wt %, a cathode active material in a range from 30 to 98 wt %, a conductive additive in a range from 0 to 30 wt %, and a binder in a range from 0 to 20 wt %. The cathode active material includes one or more materials selected from a group consisting of a rock salt layered oxide, spinel, a polyanion cathode, a lithium transition-metal oxide, a surface-coated cathode material, a doped cathode material, and a low voltage cathode material. The conductive additive includes one or more materials selected from a group consisting of carbon black, graphite, graphene, graphene oxide, Super P, acetylene black, carbon nanofibers, and carbon nanotubes. The binder include one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), and styrene butadiene styrene copolymer (SBS).

In other features, the solid electrolyte is selected from a group consisting of pseudobinary sulfide, pseudoternary sulfide, and pseudoquaternary sulfide. The solid electrolyte is selected from a group consisting of halide-based solid electrolyte and hydride-based solid electrolyte. The silicon layer is deposited using DC magnetron sputtering.

A solid-state battery cell includes a cathode electrode including a cathode current collector, and a cathode active layer arranged on the cathode current collector and including cathode active material and a solid electrolyte. A separator layer comprises the solid electrolyte. The solid electrolyte is selected from a group consisting of pseudobinary sulfide, pseudoternary sulfide, and pseudoquaternary sulfide. An anode layer includes an anode current collector having a surface roughness Rz in a range from 0.1 μm to 12 μm. A silicon layer is arranged on the anode current collector and including a plurality of concave spherical surfaces.

In other features, the silicon layer has a surface area in a range from 105% to 300% of a corresponding flat surface. The anode current collector is made of one or more materials selected from a group consisting of copper, stainless steel, nickel, iron, titanium, tin (Sn), and alloys thereof.

In other features, a depth of the concave spherical surfaces is in a range from 0.1 μm to 20 μm. The anode current collector has a thickness in a range from 4 μm to 30 μm.

In other features, the cathode active layer includes the solid electrolyte in a range from 1 to 50 wt %, the cathode active material in a range from 30 to 98 wt %, a conductive additive in a range from 0 to 30 wt %, and a binder in a range from 0 to 20 wt %. The cathode active material includes one or more materials selected from a group consisting of a rock salt layered oxide, spinel, a polyanion cathode, a lithium transition-metal oxide, a surface-coated cathode material, a doped cathode material, and a low voltage cathode material.

In other features, the conductive additive includes one or more materials selected from a group consisting of carbon black, graphite, graphene, graphene oxide, Super P, acetylene black, carbon nanofibers, and carbon nanotubes. The binder include one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), and styrene butadiene styrene copolymer (SBS). The silicon layer is deposited using DC magnetron sputtering.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell;

FIG. 2 is a side cross sectional view of an example of a battery cell including an anode electrode with concave spherical structures according to the present disclosure;

FIG. 3 is a partial side cross-sectional view of an example of the anode electrode and the separator layer according to the present disclosure;

FIGS. 4A and 4B are side cross-sectional views of an example of the anode electrode in discharged and charged states, respectfully, according to the present disclosure;

FIG. 5 is a side cross-sectional view of an example of the anode electrode showing a depth of the concave spherical structures according to the present disclosure;

FIG. 6 is a functional block diagram of an example of a DC magnetron sputtering device for depositing the silicon layer with the concave spherical structures on the anode current collector according to the present disclosure;

FIG. 7 is a graph illustrating an example of capacity retention percentage as a function of cycles for the battery cell including the silicon anode with the concave spherical structures according to the present disclosure;

FIG. 8 is a graph illustrating an example of capacity as a function of cycles for the battery cell including the silicon anode with the concave spherical structures according to the present disclosure;

FIG. 9 is a scanning electron microscope image of an example of a top surface of the silicon anode with the concave spherical structures according to the present disclosure; and

FIG. 10 is a scanning electron microscope image of an example of a side view of the silicon anode with the concave spherical structures according to the present disclosure.

In the drawings, reference numbers may be reused to identify similar and/or identical elements.

### DETAILED DESCRIPTION

While the present disclosure describes all-solid-state batteries (ASSBs) used in vehicle applications, the battery cells can be used in stationary or other types of applications.

Naturally abundant silicon (Si) is a promising anode candidate due to its multiple Li⁺ diffusion paths and high theoretical capacity. Developing high-performance anode electrodes including a silicon layer is important for constructing practical sulfide-based all-solid-state batteries (ASSBs). Generally, the Si layer of the anode electrode is fabricated using a wet-coating approach to form a sheet-type silicon layer on an anode current collector. However, the delivered rate capability and cycling of the anode electrodes with sheet-type Si layers needs to be enhanced.

The present disclosure relates to an ASSB including an anode electrode with a silicon layer having concave spherical surfaces. In some examples, the silicon layer is deposited using pulsed DC magnetron sputtering from a silicon target onto an anode current collector such as roughened copper foil. The concave spherical structures have an inverted bowl-like shape that increases silicon/electrolyte interface area and enhance the power capability of the ASSB (even at 3C). The shape of the concave spherical structures also release stress more efficiently than flat surfaces during cycling and are better able to withstand silicon expansion and contraction during cycling.

As compared to a conventional a wet coating process, pulsed DC magnetron sputtering does not require the use of binder, solvent, and/or solid electrolyte for the anode electrode, which simplifies the fabrication process.

Silicon is environmentally benign and has a reasonable electrochemical potential (˜0.3 V vs Li/Li⁺) and a high theoretical capacity (4200 mAh/g for Li_{4.4}Si)). When used in the ASSB including sulfide electrolyte as the solid electrolyte, the sulfide electrolyte can accommodate the expansion and contraction (e.g., breathing) behavior of the silicon anode electrode during cycling.

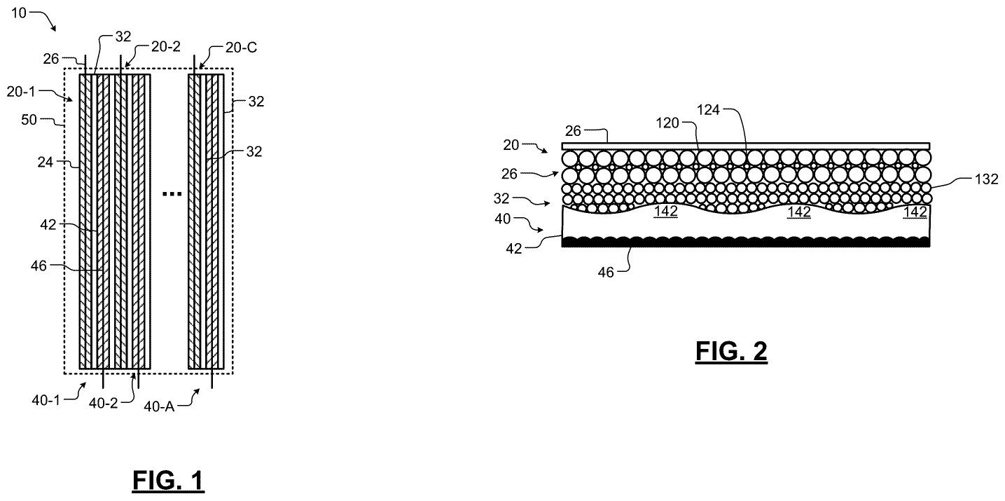

Referring now to FIG. 1, an all-solid-state battery (ASSB) cell 10 includes cathode electrodes 20, anode electrodes 40, and separator layers 32 arranged in a predetermined sequence in an enclosure 50. The cathode electrodes 20-1, 20-2, . . . , and 20-C (where C is an integer greater than one) include cathode active layers 24 arranged on one or both sides of cathode current collectors 26. The anode electrodes 40-1, 40-2, . . . , and 40-A (where A is an integer greater than one) include a silicon layer 42 on one or both sides of the anode current collectors 46.

Referring now to FIG. 2, the cathode electrodes 20 include the cathode current collector 26, a cathode active material 120, and a solid electrolyte 124 arranged on one or both sides of the cathode current collector 26. The separator layer 32 includes a solid electrolyte 132. The anode electrode 40 includes a silicon layer 42 having concave spherical surfaces 142 arranged on one or both sides of the anode current collector 46.

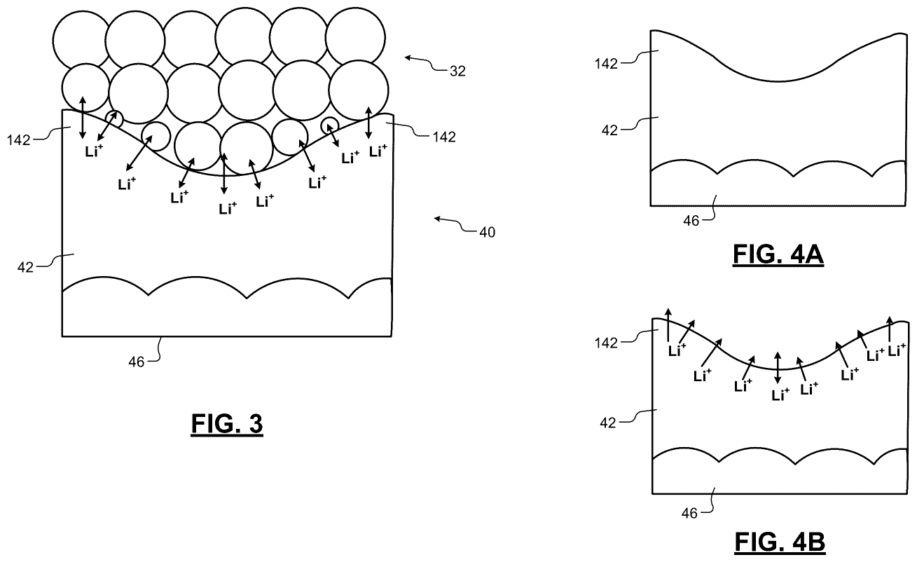

Referring now to FIGS. 3 to 5, the concave spherical surfaces 142 of the silicon layer 42 enhance performance of the anode electrodes 40. In FIG. 3, the concave spherical surfaces 142 provide increased surface area that interfaces with the solid electrolyte 132 of the separator layer 32 to increase ion conduction paths and enhance power capability. In FIGS. 4A and 4B, the concave spherical surfaces 142 help release stress during cycling and accommodate expansion and contraction of the silicon layer 42 during charging and discharging.

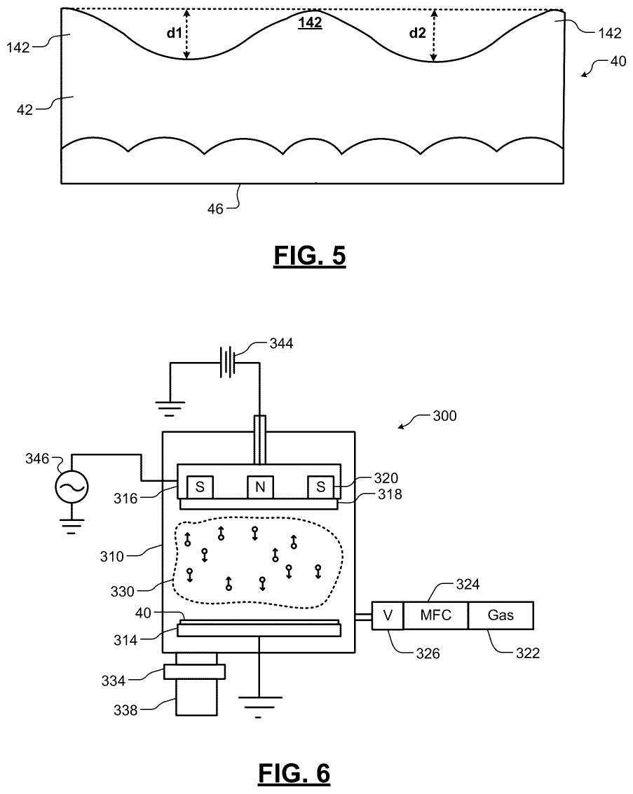

In some examples, depths d1 and d2 (FIG. 5) of the concave spherical surfaces 142 are in a range from 0.1 μm to 20 μm. The depths d1 and d2 can be the same or different. In some examples, a complex 3D surface area of the silicon layer 42 is in a range from 105% to 300% of a flat 2D surface area (e.g., x dimension times y dimension). In some examples, an average thickness of the silicon layer 42 is in a range from 1 μm to 50 μm (e.g., 8 μm).

In some examples, the anode current collector 46 is made of a material selected from a group consisting of copper, stainless steel, nickel, iron, titanium, tin (Sn), alloys thereof, and/or other conductive materials. For example, coated foil can be used such as graphene- or carbon-coated stainless steel foil (corrosion free). In some examples, the anode current collector 46 comprises a roughened copper current collector. The surface of the anode current collector 46 is a rough surface to enable tight interfaces with the silicon layer 42. In some examples, the anode current collector 46 has a thickness in a range from 4 μm to 30 μm (e.g., 18 μm) and a surface roughness R_{z} in a range from 0.1 μm to 12 μm.

Referring now to FIG. 6, a DC magnetron sputtering device 300 for depositing the silicon layer 42 with the concave spherical surfaces 142 on the anode current collector 46 is shown. The anode current collector 46 is arranged on a substrate support 314 in a processing chamber 310. A magnetron cathode 316 including magnets 320 and a target 318 is arranged above the substrate support 314.

During deposition, a process gas mixture such as argon (Ar) from a gas source 322 is introduced into the processing chamber 310 while AC and/or DC power are supplied. In some examples, a mass flow controller 324 and a valve 326 are used to meter the process gas from the gas source 322. A throttle valve 334 and/or pump 338 may be used to control pressure within the processing chamber 310 and/or to evacuate reactants from the processing chamber 310. A DC source 344 supplies DC voltage to the magnetron cathode 316. An AC source 346 supplies AC voltage to the magnetron cathode 316.

During deposition, a target material (Si) is ejected from the target 318 and deposited on the anode current collector 46. Material is also sputtered from an exposed surface of the anode current collector 46. In some examples, the silicon layer 42 with the concave spherical surfaces 142 is deposited using pulsed DC magnetron sputtering in an argon (Ar) atmosphere. In some examples, a silicon target (e.g., n-type; 99.995%) sputters silicon particles onto a roughened anode current collector (e.g., copper foil).

In some examples, the DC source 344 supplies DC voltage in a range from 200V to 800V (e.g., 450V). In some examples, cathode power from the AC source 346 is in a range from 2 to 30 KW at a frequency in a range from 20 to 200 kHz. In some examples, a deposition period is in a range from 20 to 840 minutes (e.g., 540 minutes).

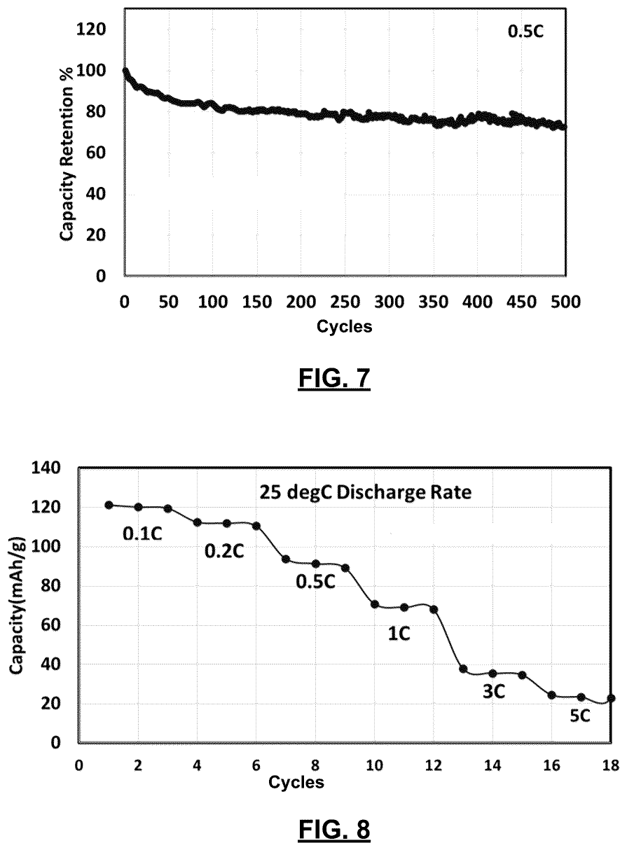

Referring now to FIGS. 7 and 8, performance of the battery cells including the bowl-like silicon layer is shown. In FIG. 7, capacity retention percentage is shown as a function of cycles. In FIG. 8, capacity is shown as a function of cycles. Due to the unique concave surfaces, battery cells with the silicon layer 42 exhibit good rate capability and good cell cycling.

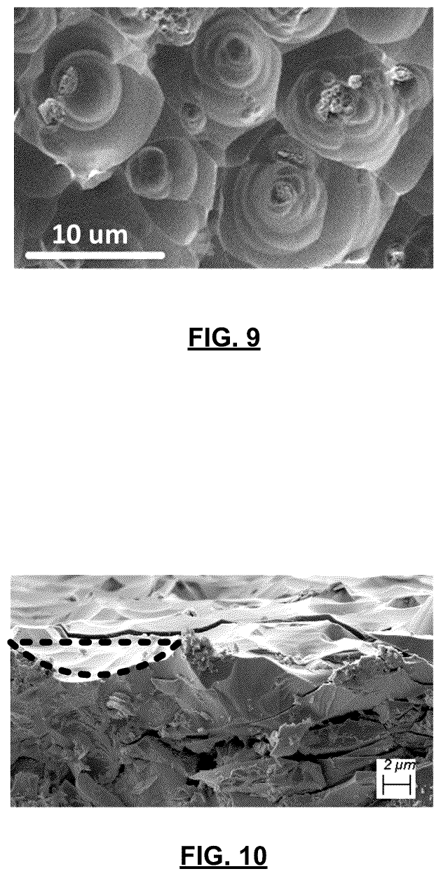

Referring now to FIGS. 9 and 10, scanning electron microscope images of a top surface of the silicon layer 42 are shown. The concave spherical structures are deposited in a contiguous fashion on an exposed surface of the anode current collector 46. In the examples shown in FIG. 9, the average diameter of the concave spherical structure concave is approximately 6˜10 μm. In FIG. 10, a concave portion has a depth of approximately 2 μm.

In some examples, the cathode active layer comprises solid electrolyte (in a range from 1 to 50 wt %), cathode active material (in a range from 30 to 98 wt %), conductive additive (in a range from 0 to 30 wt %), and a binder (in a range from 0 to 20 wt %). In some examples, the cathode electrode has a thickness in a range from 10 μm to 500 μm (e.g., 40 μm).

In some examples, the cathode active material includes one or more materials selected from a group consisting of a rock salt layered oxide, spinel, a polyanion cathode, a lithium transition-metal oxide, a surface-coated and/or doped cathode material, and a low voltage cathode material.

Examples of rock salt layered oxides include LiCoO₂, LiNiₓMn_{y}Co_{1-x-y}O₂, LiNiₓMn_{y}Al_{1-x-y}O₂, LiNiₓMn₁₋ₓO₂, Li₁₊ₓ MO₂. Examples of spinel include LiMn₂O₄, LiNi_{0.5}Mn_{1.5}O₄. Examples of polyanion cathodes include LiV₂(PO₄)₃. Examples of surface-coated and/or doped cathode materials include LiNbO₃-coated LiMn₂O₄, Li₂ZrO₃ or Li₃PO₄-coated LiNiₓMn_{y}Co_{1-x-y}O₂, and Al-doped LiMn₂O₄. Examples of low voltage cathode materials include lithiated metal oxide/sulfide (e.g., LiTiS₂), lithium sulfide, and sulfur.

In some examples, the conductive additive includes one or more materials selected from a group consisting of carbon black, graphite, graphene, graphene oxide, Super P, acetylene black, carbon nanofibers, carbon nanotubes, and other electronically conductive additives. Examples of binder include one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS) and other suitable binders.

In some examples, the solid electrolyte in the separator layer and/or cathode electrode is selected from a group consisting of pseudobinary sulfide, pseudoternary sulfide, pseudoquaternary sulfide, halide-based solid electrolyte, and hydride-based solid electrolyte.

Examples of pseudobinary sulfide include Li₂S-P₂S₅ system (Li₃PS₄, Li₇P₃S₁₁ and Li_{9.6}P₃S₁₂), Li₂S-SnS₂ system (Li₄SnS₄), Li₂S-SiS₂ system, Li₂S-GeS₂ system, Li₂S-B₂S₃ system, Li₂S-Ga₂S₃ system, Li₂S-P₂S₃ system, Li₂S-Al₂S₃ system. Examples of pseudoternary sulfide include Li₂O-Li₂S-P₂S₅ system, Li₂S-P₂S₅-P₂O₅ system, Li₂S-P₂S₅-GeS₂ system (Li_{3.25}Ge_{0.25}P_{0.75}S₄ and Li₁₀GeP₂S₁₂), Li₂S-P₂S₅-LiX (X=F, Cl, Br, I) system (Li₆PS₅Br, Li₆PS₅Cl, L₇P₂S₈I and Li₄PS₄I), Li₂S-As₂S₅-SnS₂ system (Li_{3.833}Sn_{0.833}As_{0.166}S₄), Li₂S-P₂S₅-Al₂S₃ system, Li₂S-LiX-SiS₂ (X=F, Cl, Br, I) system, and 0.4Lil·0.6Li₄SnS₄ and Li₁₁Si₂PS₁₂. Examples of pseudoquaternary sulfide include Li₂O-Li₂S-P₂S₅-P₂O₅ system, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂

Examples, of halide-based solid electrolyte include Li₃YCl₆, Li₃InCl₆, Li₃YBr₆, Lil, Li₂CdCl₄, Li₂MgCl₄, Li₂CdI₄, Li₂ZnI₄, Li₃OCI. Examples of hydride-based solid electrolyte include LiBH₄, LiBH₄-LiX (X=CI, Br or I), LiNH₂, Li₂NH, LiBH₄-LiNH₂, Li₃AlH₆. In other examples, other types of solid electrolyte with low grain-boundary resistance can be used.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A solid-state battery cell comprising:
a cathode electrode comprising:
a cathode current collector; and
a cathode active layer arranged on the cathode current collector and including cathode active material and a solid electrolyte;
a separator layer comprising the solid electrolyte; and
an anode layer comprising:
an anode current collector; and
a silicon layer arranged on the anode current collector and including a plurality of concave spherical surfaces.

2. The solid-state battery cell of claim 1, wherein the silicon layer has a surface area in a range from 105% to 300% of a corresponding flat surface.

3. The solid-state battery cell of claim 1, wherein the anode current collector is made of one or more materials selected from a group consisting of copper, stainless steel, nickel, iron, titanium, tin (Sn), and alloys thereof.

4. The solid-state battery cell of claim 1, wherein the anode current collector has a surface roughness R_{z} in a range from 0.1 μm to 12 μm.

5. The solid-state battery cell of claim 1, wherein a depth of the concave spherical surfaces is in a range from 0.1 μm to 20 μm.

6. The solid-state battery cell of claim 1, wherein the anode current collector has a thickness in a range from 4 μm to 30 μm.

7. The solid-state battery cell of claim 1, wherein the cathode active layer includes the solid electrolyte in a range from 1 to 50 wt %, a cathode active material in a range from 30 to 98 wt %, a conductive additive in a range from 0 to 30 wt %, and a binder in a range from 0 to 20 wt %.

8. The solid-state battery cell of claim 7, wherein the cathode active material includes one or more materials selected from a group consisting of a rock salt layered oxide, spinel, a polyanion cathode, a lithium transition-metal oxide, a surface-coated cathode material, a doped cathode material, and a low voltage cathode material.

9. The solid-state battery cell of claim 7, wherein the conductive additive includes one or more materials selected from a group consisting of carbon black, graphite, graphene, graphene oxide, Super P, acetylene black, carbon nanofibers, and carbon nanotubes.

10. The solid-state battery cell of claim 7, wherein the binder include one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), and styrene butadiene styrene copolymer (SBS).

11. The solid-state battery cell of claim 1, wherein the solid electrolyte is selected from a group consisting of pseudobinary sulfide, pseudoternary sulfide, and pseudoquaternary sulfide.

12. The solid-state battery cell of claim 1, wherein the solid electrolyte is selected from a group consisting of halide-based solid electrolyte and hydride-based solid electrolyte.

13. The solid-state battery cell of claim 1, wherein the silicon layer is deposited using DC magnetron sputtering.

14. A solid-state battery cell comprising:
a cathode electrode comprising:
a cathode current collector; and
a cathode active layer arranged on the cathode current collector and including cathode active material and a solid electrolyte;
a separator layer comprising the solid electrolyte,
wherein the solid electrolyte is selected from a group consisting of pseudobinary sulfide, pseudoternary sulfide, and pseudoquaternary sulfide; and
an anode layer comprising:
an anode current collector having a surface roughness R_{z} in a range from 0.1 μm to 12 μm; and
a silicon layer arranged on the anode current collector and including a plurality of concave spherical surfaces.

15. The solid-state battery cell of claim 14, wherein:
the silicon layer has a surface area in a range from 105% to 300% of a corresponding flat surface; and
the anode current collector is made of one or more materials selected from a group consisting of copper, stainless steel, nickel, iron, titanium, tin (Sn), and alloys thereof.

16. The solid-state battery cell of claim 14, wherein:
a depth of the concave spherical surfaces is in a range from 0.1 μm to 20 μm; and
the anode current collector has a thickness in a range from 4 μm to 30 μm.

17. The solid-state battery cell of claim 14, wherein:
the cathode active layer includes the solid electrolyte in a range from 1 to 50 wt %, the cathode active material in a range from 30 to 98 wt %, a conductive additive in a range from 0 to 30 wt %, and a binder in a range from 0 to 20 wt %; and
the cathode active material includes one or more materials selected from a group consisting of a rock salt layered oxide, spinel, a polyanion cathode, a lithium transition-metal oxide, a surface-coated cathode material, a doped cathode material, and a low voltage cathode material.

18. The solid-state battery cell of claim 17, wherein the conductive additive includes one or more materials selected from a group consisting of carbon black, graphite, graphene, graphene oxide, Super P, acetylene black, carbon nanofibers, and carbon nanotubes.

19. The solid-state battery cell of claim 17, wherein the binder include one or more materials selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), and styrene butadiene styrene copolymer (SBS).

20. The solid-state battery cell of claim 14, wherein the silicon layer is deposited using DC magnetron sputtering.
